(19) United States
(12) Patent Application Publication
(10) Pub. No.: US 2015/0302535 A1
(43) Pub. Date: Oct. 22, 2015

(54) METHOD AND SYSTEM FOR VISUALIZING COMPETENCY BASED LEARNING DATA IN DECISION MAKING DASHBOARDS

(71) Applicant: University of Central Oklahoma, Edmond, OK (US)

(72) Inventor: Bucky J. Dodd, Edmond, OK (US)

(73) Assignee: UNIVERSITY OF CENTRAL OKLAHOMA

(21) Appl. No.: 14/668,288

(22) Filed: Mar. 25, 2015

Related U.S. Application Data
(60) Provisional application No. 61/969,980, filed on Mar. 25, 2014.

(51) Int. Cl. G06Q 50/20; G09B 19/00; G09B 5/00

(52) U.S. Cl. CPC G06Q 50/2053; G09B 5/00; G09B 19/00

(57) ABSTRACT

A method and system for visualizing competency based learning data in decision making dashboards, including a database system that integrates all relevant data about a learner's past learning events transformed and aligned using a defined competency model; a process for recommending future learning opportunities based upon a learner's current competency based performance and identifying future learning events the learner would need to fulfill for a specific competency; creating and graphically displaying a learner's performance on a competency model and presenting future learning opportunities to the learner, and a learner dashboard interface usable by the learner to view their past competency based learning records and suggestions for future learning opportunities.

### CROSS REFERENCES TO RELATED APPLICATIONS

This application claims the benefit of U.S. Provisional Patent Application No. 61/969,980 filed on Mar. 25, 2014 in the name of Bucky Dodd, which is expressly incorporated herein by reference in its entirety.

### FIELD OF THE INVENTION

This invention relates to data visualization, and in particular, the visualization of competency based data for student and adult learners, and recommending future competency-based learning events based on strategic human resource development needs.

### REFERENCE TO COMPUTER PROGRAM LISTING APPENDICES

A portion of the disclosure of this patent document contains material that is subject to copyright protection. The copyright owner has no objection to the facsimile reproduction by anyone of the patent document or the patent disclosure, as it appears in the Patent and Trademark Office patent file records, but otherwise reserves all copyright rights whatsoever.

Computer program listings corresponding to the program listings identified below, are filed herewith in Appendix A, respectively. The complete computer program listing of Appendix A is incorporated herein by reference. The referenced listings were created on Mar. 3, 2014.

Exemplary computer program code listing for a prototype filed herewith in Appendix A illustrates how various elements of the present invention can come together. The exemplary computer program code listing includes a limited working dashboard prototype with local html data. The code is annotated to show how elements may be integrated together. The code is 27 pages, and provides a detailed implication approach. The computer program code presented in

Appendix A is operable as a web app on the iPad available from Apple, Inc. The computer program code presented in Appendix A may be ported to function on mobile devices available from a plurality of manufactures such as Samsung, Dell, Google, Microsoft, and Hewlett Packard.

Three third-party webkits were used to develop the prototype. Third-party components/webkits used to develop prototype of dashboard are as follows:
Highcharts http://www.highcharts.com/Bootstrap
http://getbootstrap.com/jQuery
Mobile http://jquerymobile.com/These
webkits are also listed within the source code example in Appendix A as calls.

### Appendix A Table of Contents for Source Code Display

Graphical Dashboard Display Code—Initial State
Graphical Dashboard Display Code—Detailed Window State
Graphical Dashboard Display Code—Recommendations Display Basic State
Graphical Dashboard Display Code—Recommendations Display Detail State
Concept Prototype Process Code—User Experience Design
   Layers
   States
   Interactive Elements
Prototype Code—Web-based Dashboard Display
   General HTML Metadata
   Call third-party stylesheet. Example uses Bootstrap library.
   Call third-part mobile libraries. Example uses jquery mobile.
   Javascript functions for generating data visualizations. Uses thirdpary highcharts.js library.
   Call third-party visualization library. Example uses highcharts.js library.
   Code for recommendation panel and associated data.
   Code for visualization table.
   Loads visualization assets in table.
   Calls dialogue box for detail view.
   Opens recommendation panel.
   Calls third-party javascript library. Example uses bootstrap.
Prototype Dashboard Display—Initial State
Prototype Dashboard Display—Detailed Window State

### Prototype Dashboard Display—Recommendation Panel

### BACKGROUND OF THE INVENTION

Competency based education is an emerging trend in higher education, government, and corporations. Competency based education is the practice of aligning instructional and learning opportunities to defined learning outcomes. Competencies often describe a grouping of knowledge, skills, and abilities that are required in a given discipline or occupation. As competency based education continues to gain acceptance among learners and organizations, there remain critical gaps in how competency based learning opportunities and data about learners' prior experiences can be communicated to learners and relevant stakeholders.

Presently, learners generally have limited access to useable data about their personal competency based learning records. This makes it difficult for learners to make the best decisions about their own education and learning opportunities. Current methods and systems designed for learners tend to focus on displaying performance in a single course or are based on historical data mining techniques for courses in a program of study. These methods are not well positioned to address competency based data which is focused on specific knowledge and skills that may be associated with a course or program, but are specific to each learner's past experiences. Furthermore, currently available learning analytics and visualization systems are designed for displaying data to educators and organizational leaders. Learners typically have minimal, if any, opportunities, to view their own competency based learning records over time and make decisions based on that information in real time. Currently learners must rely on the interpretation of individuals and highly unusable technical systems to make decisions and analyze competency based data. A system and method is needed that addresses the problem of data and visual literacy by visualizing complex competency based data in a format for learners that is easy to use and understand, while providing recommendations for future competency-based learning events based on strategic human resource development needs.

### SUMMARY OF THE INVENTION

In a broad aspect, the apparatus of the present invention visualizes and makes recommendations about future learning opportunities and events that would strengthen a competency for a learner. The apparatus displays for learners historical competency based records so that the learner has the capability to take ownership in their own education and learning decision-making process.

In another aspect, the apparatus of the present invention visualizes data associated with competency based learning records in dashboard architectures that aid learners in making critical decisions about their past, present, and future learning experiences. The structure and representation of the dashboard architectures enables visual representation of the data in ways that help learners better understand their past learning experiences, while helping to identify future learning opportunities that augment performance on a set of defined competencies.

In another aspect, the apparatus of the present invention provides a method for creating decision models for recommending future learning events using learning records based on a competency learning structure and strategic human resource development priorities.

In another aspect, the apparatus of the present invention provides decision-models that define how competency-aligned learning experiences are recommended and establish the interoperable component that can be applied to diverse learning-recommendation systems.

In another broad aspect, the apparatus of the present invention captures competency data, which is often available in organizations, and creates visualizations that show the learner their performance in relation to each competency. The structure of the present invention brings together key data sources, processes, competency models, and visualization systems that may be focused in a simple user interface that helps individuals make better decisions about their past and future learning experiences.

In another broad aspect, the apparatus of the present invention integrates data contained in legacy systems together in a dashboard interface that is particularly designed and adapted for learners. The apparatus of the present invention enables competency based data to be visualized on an ongoing basis which allows learner to track their education and learning progress over time.

In another aspect, a Learner Dashboard Interface is provided and designed to display competency based data and future learning recommendations in a visual dashboard that allows learners to interact with and better understand their educational history. This dashboard may be used in educational settings or in workplace learning and development settings that use a competency based approach.

In another broad aspect, the present invention provides a method for taking competency based learning data and displaying it in a visual dashboard that is accessed directly by learners. A visual dashboard is provided as a digital display that presents data graphics in a quickly referenced visual format. The visual dashboards may be used for displaying organizational data to support key learner decision making processes. The visual dashboards may be used to display competency data that helps learners make better decisions about their past learning experiences (i.e. courses, workshops, etc.) as each relates to defined organizational competency models.

In another aspect, the method of the present invention provides competency model grouping of learners' knowledge, skills, and abilities that are recognized and valued within organizations or a profession.

In another aspect, the method of the present invention allows learners to see their past learning performance aligned with an organization's competency model and make decisions about which future learning events best meet their education and learning goals.

In another aspect, a learner may access the dashboard to view their performance towards a specific competency compared with their performance across all competencies.

In yet another aspect, a learner may discover which future learning opportunities may help them further develop the knowledge and skills needed in a certain competency.

In another broad aspect, the present invention provides a method for using multiple sources of educational records (i.e. grades, course scores, rubric assessments etc.), defined competency models, and future learning opportunities and presenting that information in a visual dashboard interface that can be used by learners. This method allows learners to better understand their past educational data and make decisions that best align with their goals.

In another aspect, the present invention provides a method that presents past learning performance transformed to align with an organization's competency model and provides a framework for making decisions about which future learning events best meet a learner's education and learning goals.

In another aspect, the method incorporates a dashboard to present learner performance directed towards a specific competency and enables comparison with learner performance across all competencies.

In another aspect, the method enables learner discovery of future learning opportunities may help them further develop the knowledge and skills needed in a certain competency.

In another aspect, the method enables recommending future learning events based on competency achievement and strategic human resource development priorities, using an interoperable approach to creating recommendation decision models for competency-based learning events.

In another aspect, the recommendation decision models use data transformed from a competency aligned learning records data store, future competency-aligned learning events, competency models, and talent-aligned human resource development innovation models.

### BRIEF DESCRIPTION OF THE DRAWINGS

FIG. 1 is a non-limiting diagram showing how the method of the present invention integrates with common competency based education and learning environments.

FIG. 2 is a non-limiting diagram showing top-level components and relationships of the invention.

FIG. 3 is a non-limiting diagram showing a process for determining future learning recommendations.

FIG. 3A is a non-limiting diagram providing an example of a matrix that may be generated for identifying competency based learning opportunities.

FIG. 4 is a non-limiting diagram showing a process for developing visualization assets of competency based learning records and future learning recommendations.

FIG. 5 is a non-limiting diagram showing a design and development process for creating visual interface of competency based learning records and future learning recommendations.

FIG. 6 is a non-limiting diagram providing an example visualization display showing three levels of five competencies.

FIG. 7 is a non-limiting diagram providing an example display showing individual performance on a competency category.

FIG. 8 is a non-limiting diagram providing an example display showing individual learner recommendations for future learning opportunities.

FIG. 9 is a non-limiting diagram providing an example display showing a learning opportunity profile with registration capabilities.

FIG. 10 illustrates a sample structure of the Competency Aligned Learning Records Data Store.

FIG. 11 is a non-limiting, high level system diagram showing the components and relationships for how a learning event is recommended using the recommendation decision model approach.

FIG. 12 is a non-limiting, conceptual representation of how competency-based data is applied to the competency-based decision model and used to determine recommendations based on decision rules.

FIG. 13 is a non-limiting example of a decision model that could be used to recommend future competency-aligned learning events.

FIG. 14 is a non-limiting diagram showing key attributes of a competency.

FIG. 15 is a non-limiting diagram showing present invention implemented in cloud-based architecture.

### DETAILED DESCRIPTION OF PREFERRED EMBODIMENTS OF THE INVENTION

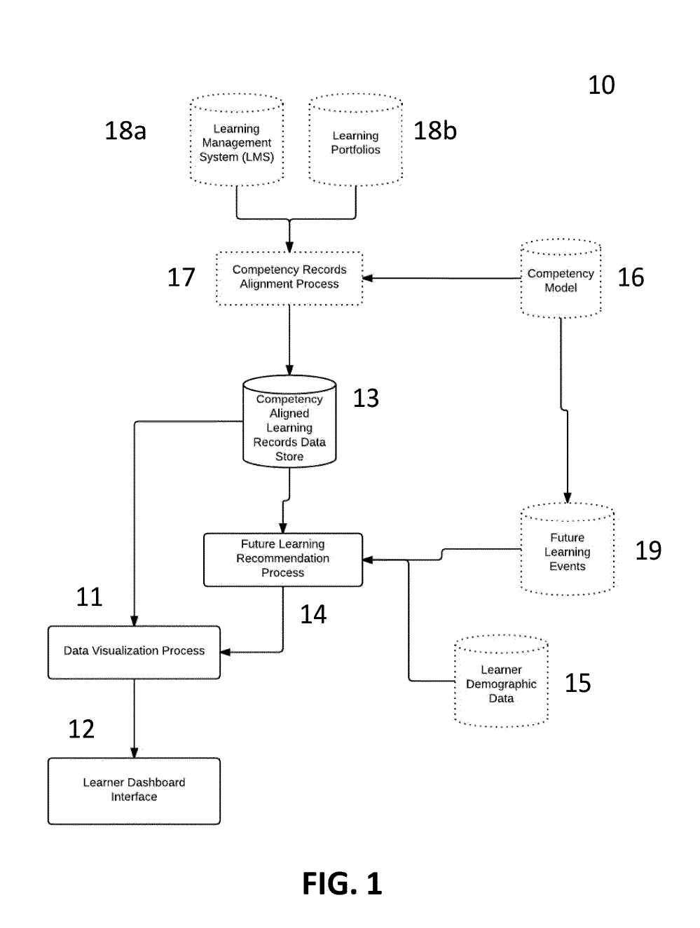

In brief: FIG. 1 is a non-limiting diagram showing how the method of the present invention integrates with common competency based education and learning environments. FIG. 1 illustrates the high level system architecture of the invention. The highlighted components are primary method elements of the invention. Other elements shown in the diagram indicate relationships with common competency based education and learning environment components. The invention serves as a visualization and communication component for competency based learning. The diagram in FIG. 1 shows how elements specific to the present invention connect with and support other data elements and processes.

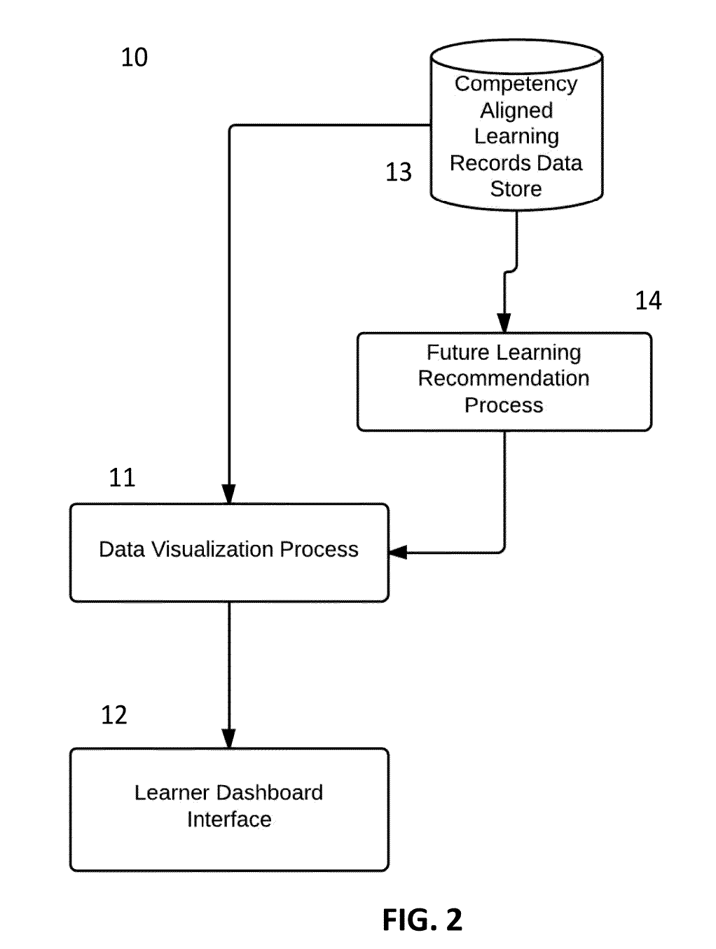

FIG. 2 is a non-limiting diagram showing top-level components and relationships of the present invention, and illustrates core systematic elements. The diagram in FIG. 2 shows learning records that have been transformed and aligned with competency models and where they may be used in the Future Learning Recommendation Process and the Data Visualization Process. The Data Visualization Process may then be used to create a Learner Dashboard that displays both historical competency based learning records and future learning opportunities for learners.

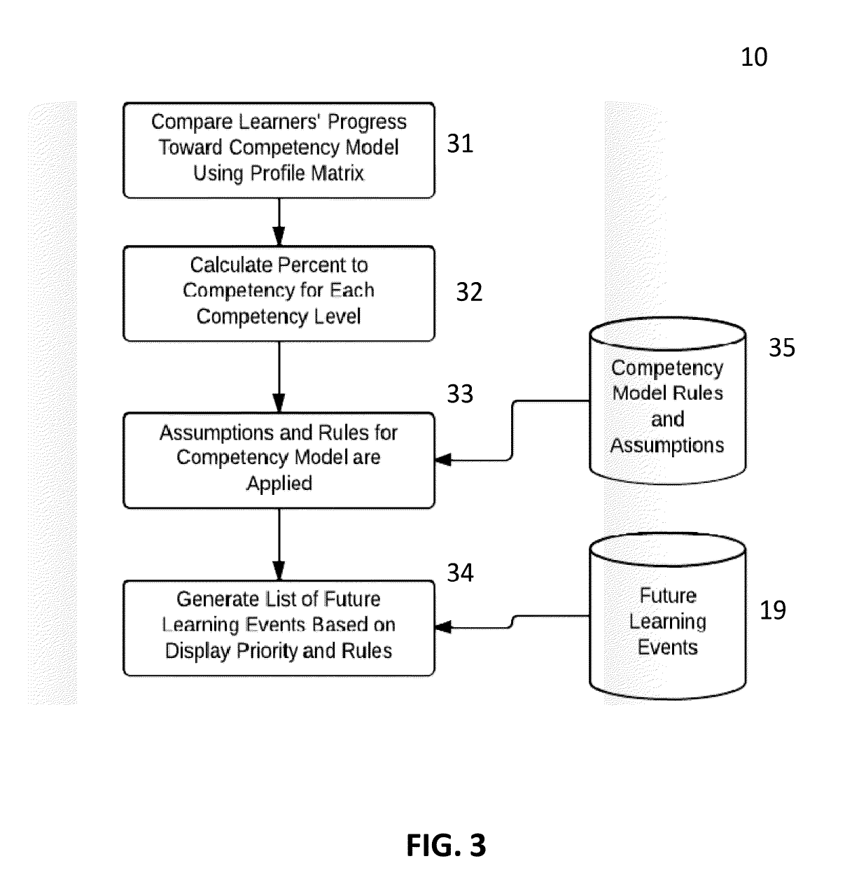

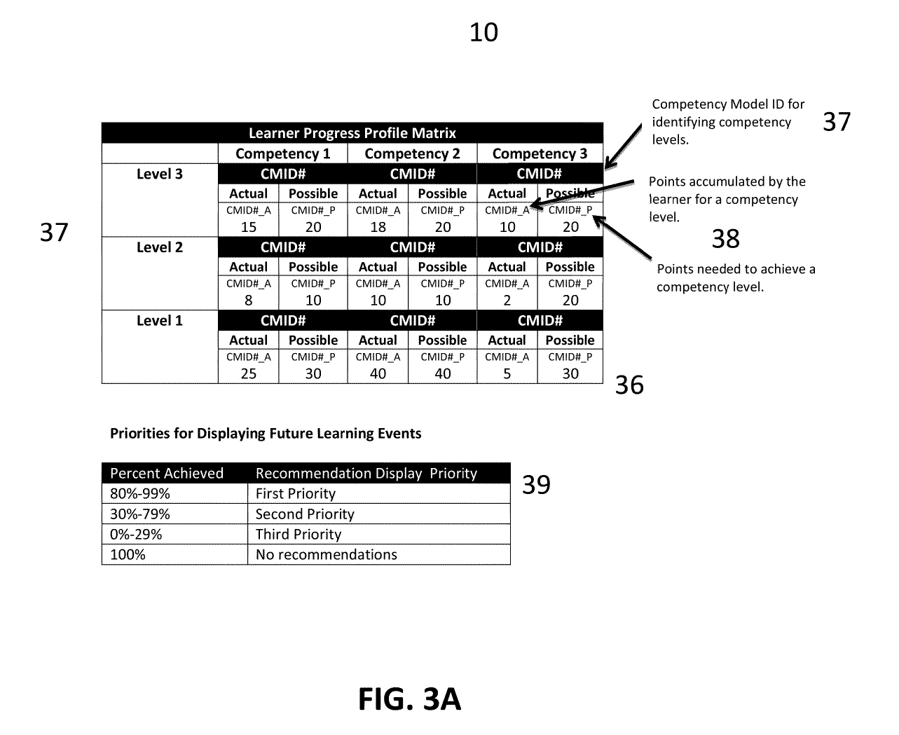

FIG. 3 is a non-limiting diagram showing a process for determining future learning recommendations. FIG. 3 shows how future learning recommendations may be determined using the present invention. First, a learner's prior learning records may be analyzed and a matrix developed that identifies a learner's performance on each level of a competency model. Using the profile matrix, the learner's progress may be calculated for each competency level by determining a percent to achievement for each level. Using predetermined display priorities, a list of future learning events that meet the display criteria may be generated.

FIG. 3A is a non-limiting diagram providing an example of a matrix that may be generated for identifying competency based learning opportunities. In this example, presented in black and white, the competency model has three competencies each with three performance levels. Each competency level is assigned a specific identifier. This identifier is used for aligning past and future learning events with the model. The matrix may use color coding in visualizing the correlation between the Learner Progress Profile and the Recommendation Display.

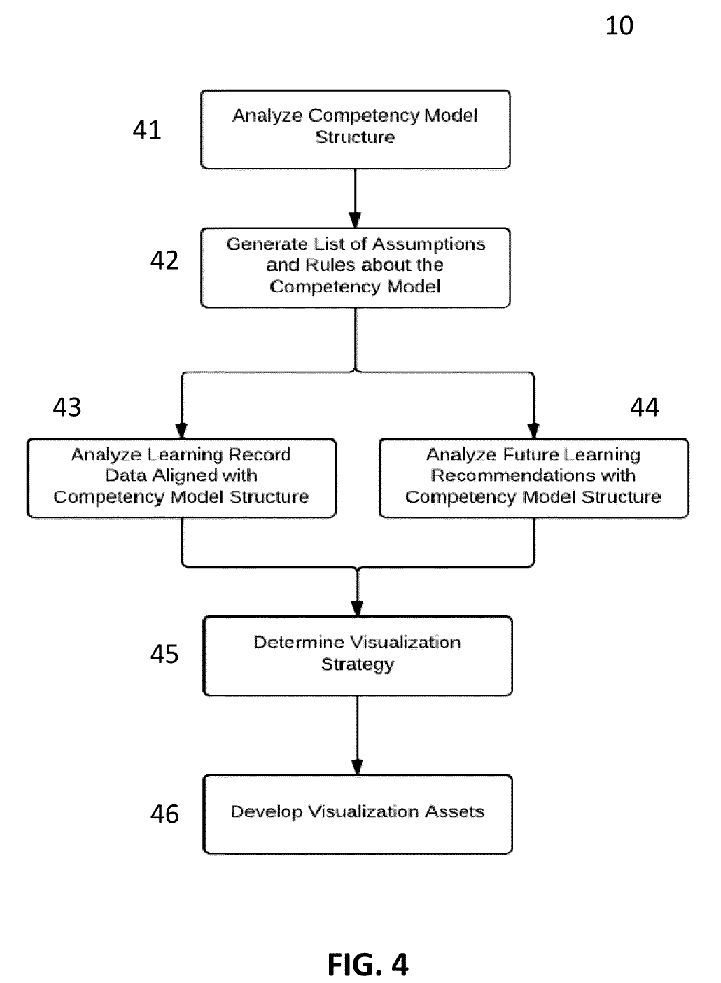

FIG. 4 is a non-limiting diagram showing a process for developing visualization assets of competency based learning records and future learning recommendations. FIG. 4 is an illustration showing how data visualization assets may be developed in the present invention. First, the competency model may be analyzed to determine its characteristics and components. Next, this analysis may be used to filter the competency based learning records and future learning opportunities. After these filters are applied, a visualization strategy may be determined that best conveys the meaning of both historical competency based learning records and future learning recommendations. Finally, visualization assets may be developed based on the visualization strategy.

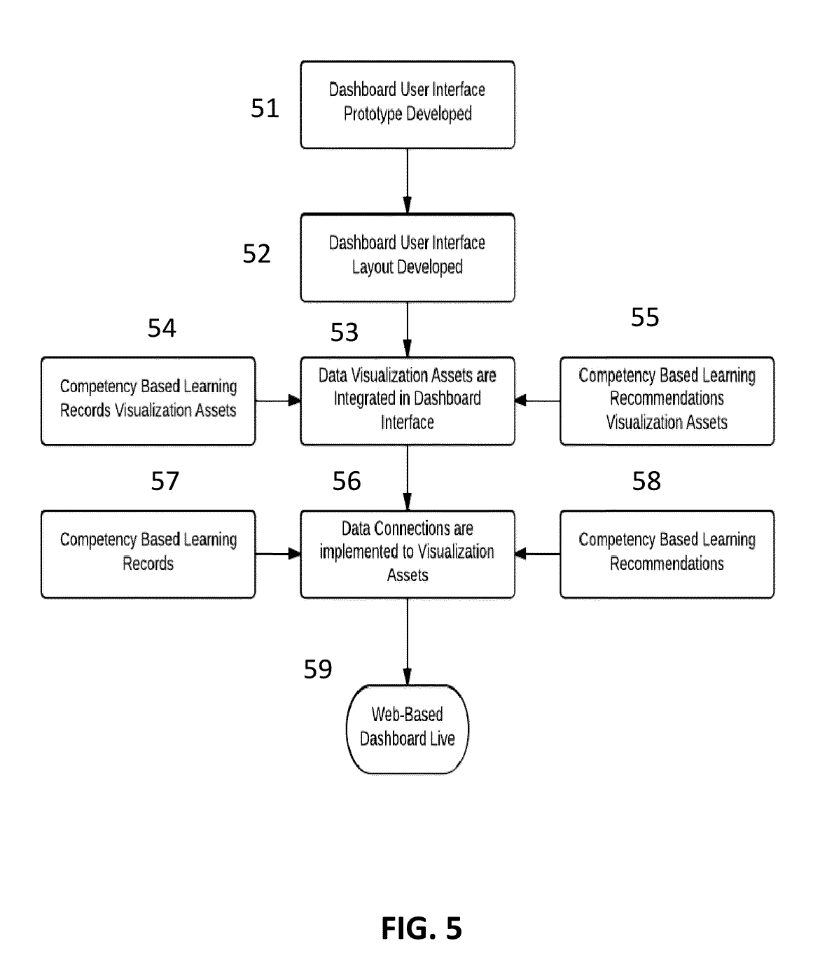

FIG. 5 is a non-limiting diagram showing a design and development process for creating visual interface of competency based learning records and future learning recommendations. FIG. 5 shows a diagram of a design and development process of the present invention wherein a visual interface may be created that integrates the competency based learning records visualizations and the future learning recommendation visualizations. First, a unified visual dashboard prototype concept may be developed. Next, the visual interface may be developed that integrates the learning records visualization assets and the learning recommendation visualization assets. Finally, a web-enabled learner dashboard may be assembled and delivered on Internet enabled devices.

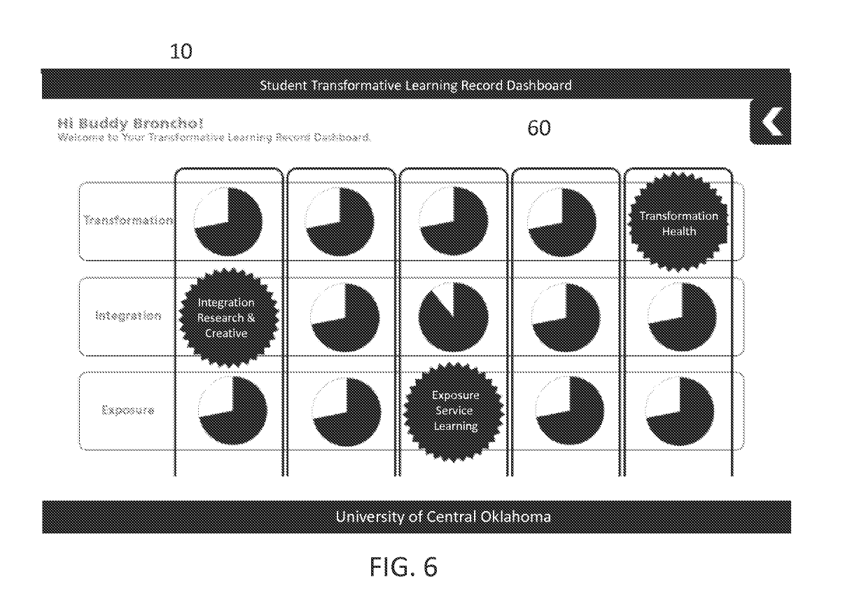

FIG. 6 is a non-limiting diagram (presented in black and white) providing an example visualization display showing three levels of five competencies. FIG. 6 provides an example of a data visualization of a learner's historical competency based learning records using the present invention. This dashboard is viewable on a tablet device and incorporates visual elements meaningful to the learner within the context of their organization. In this example, badges are used to show achievement of a given competency element, while small multiples are used to show progress toward competency based criteria. Color or gray scale may be used in implementations to better visualize the data displayed.

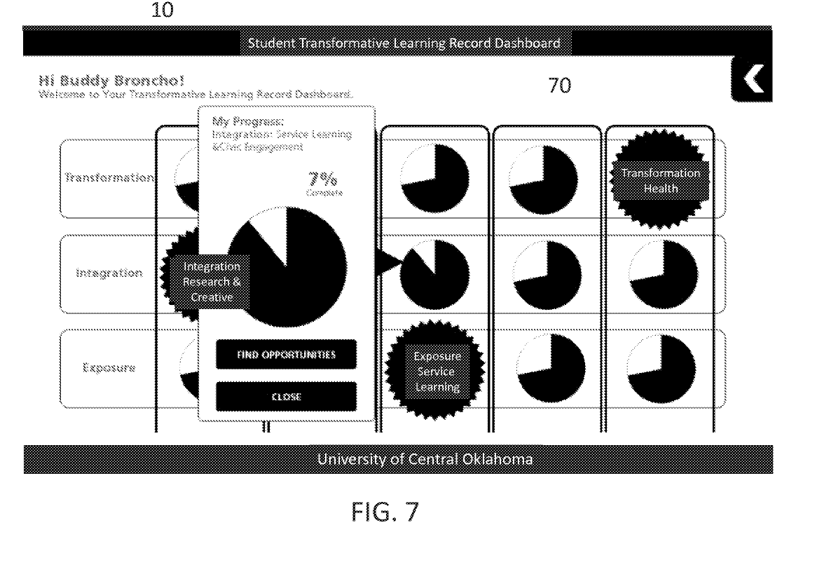

FIG. 7 is a non-limiting diagram (presented in black and white) providing an example display showing individual performance on a competency category. FIG. 7 shows an example of a competency based visualization with a detail screen active for a specific competency level. The detail screen displays the learner's progress for that competency level and provides a call to action to find specific future learning opportunities that would help the learner advance that competency. Color or gray scale may be used in implementations to better visualize the data displayed.

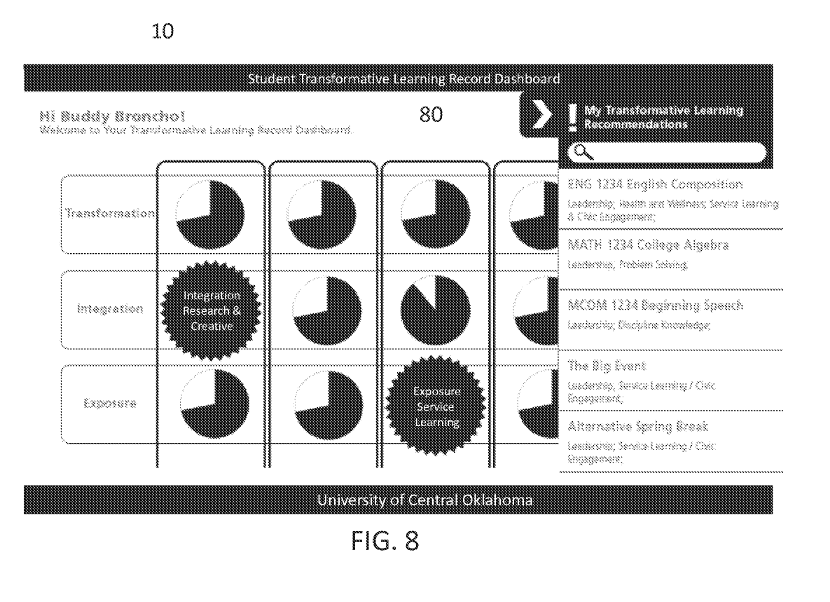

FIG. 8 is a non-limiting diagram (presented in black and white) providing an example display showing individual learner recommendations for future learning opportunities. FIG. 8 shows an example of the visual competency based learner dashboard interface with future learning recommendations shown. In this example, the recommendations are based on the learner's past competency records and highlights key future learning pathways that align with the competency model and the learner's progress based on the competency model. Color or gray scale may be used in implementations to better visualize the data displayed.

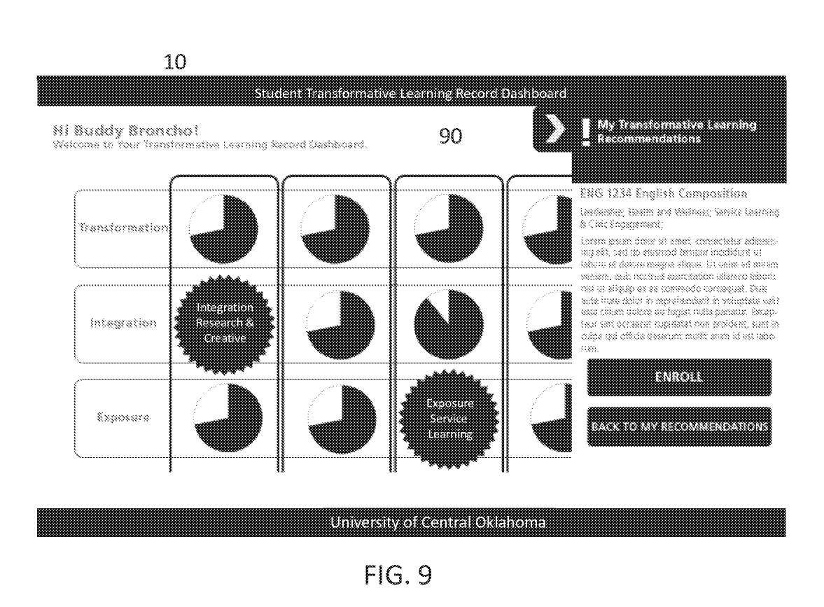

FIG. 9 is a non-limiting diagram (presented in black and white) providing an example display showing a learning opportunity profile with registration capabilities. FIG. 9 is an example of a visual competency based interface showing a selected future learning opportunity. In the example, the detail dialogue displays the title and description, and provides a call to action to register for a learning opportunity. Completing this learning opportunity would contribute to a learner's completion of aligned learning events. Color or gray scale may be used in implementations to better visualize the data displayed.

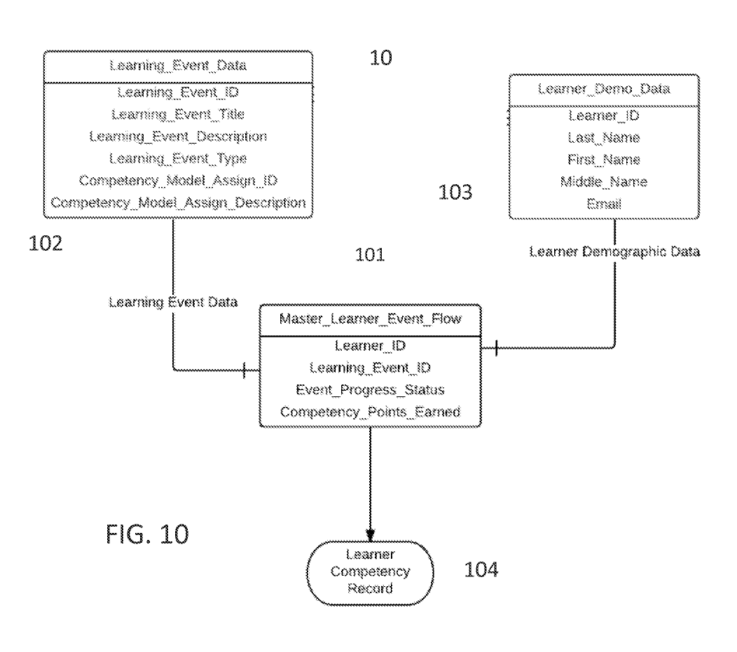

FIG. 10 illustrates a sample structure of the Competency Aligned Learning Records Data Store. This database is designed to align learners' prior learning records with performance data towards a predefined competency model. This diagram shows the Master Learning Event Flow which is a total list of a learner's prior learning records.

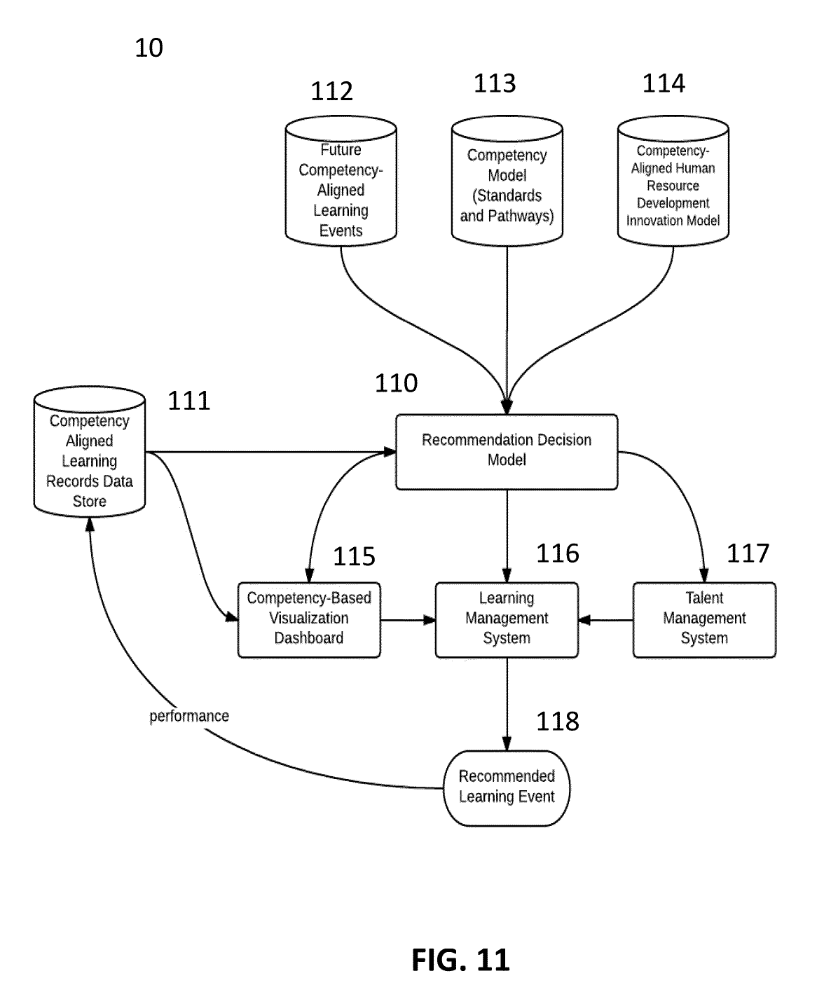

FIG. 11 is a non-limiting, high level system diagram showing the components and relationships for how a learning event is recommended using the recommendation decision model approach. In this system, the recommendation decision model uses data from a learner's historical learning record aligned with competencies (Competency Aligned Learning Records Data Store), future learning events aligned with competencies, competency models, standards and the pathways used to achieve those competencies (i.e. course sequences, certificates, etc.), and competency-aligned human resource development innovation models (i.e. competency models based on achieving strategic priorities in an organization).

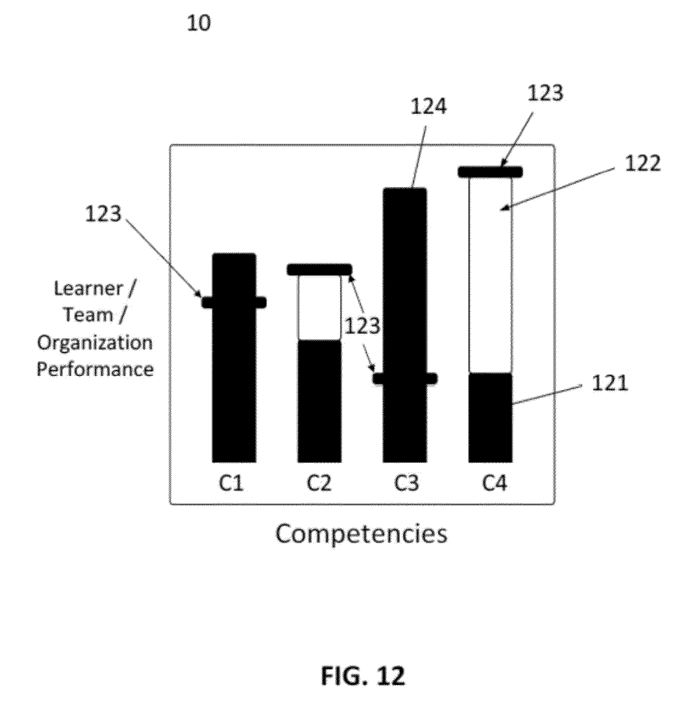

FIG. 12 is a non-limiting conceptual representation of how competency-based data is applied to the competency-based decision model and used to determine recommendations based on decision rules. The bottom section of each bar is competency achievement which is the learners' historical performance towards a competency. Portions of the bar, presented in black and white, that are shared represent competency gaps. Color or gray scale may be used in implementations to better visualize the data displayed.

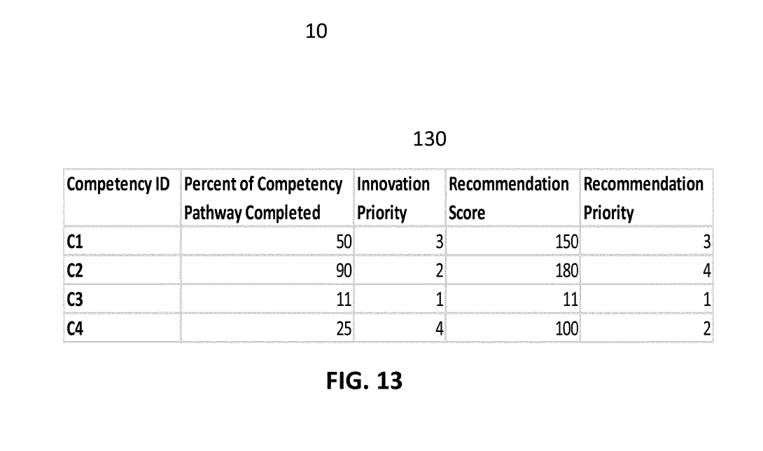

FIG. 13 is a non-limiting example of a decision model (presented in black and white) that could be used to recommend future competency-aligned learning events. In this decision model, the competencies are listed in the first column. The second column is the percent of the complete competency pathway. The third column is the innovation priority which defines the priority placed on that competency based on strategic human resource development needs. The fourth column is the recommendation score and in this model, is calculated by multiplying the percent of the pathway complete with the priority number. The recommendation priority defines which learning events are recommended in a given priority based on their alignment with a competency. Color or gray scale may be used in implementations to better visualize the data displayed.

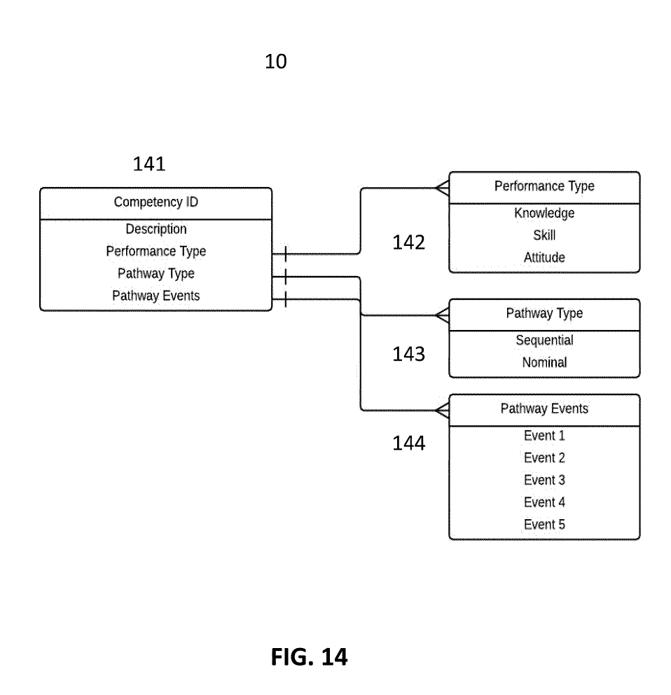

FIG. 14 is a non-limiting diagram (presented in black and white) showing key attributes of a competency. The competency idea contains a description, performance type (knowledge, skill, attitude), pathway type (sequential, nominal), and the events that make up the pathway to achieving the competency. Color or gray scale may be used in implementations to better visualize the data displayed.

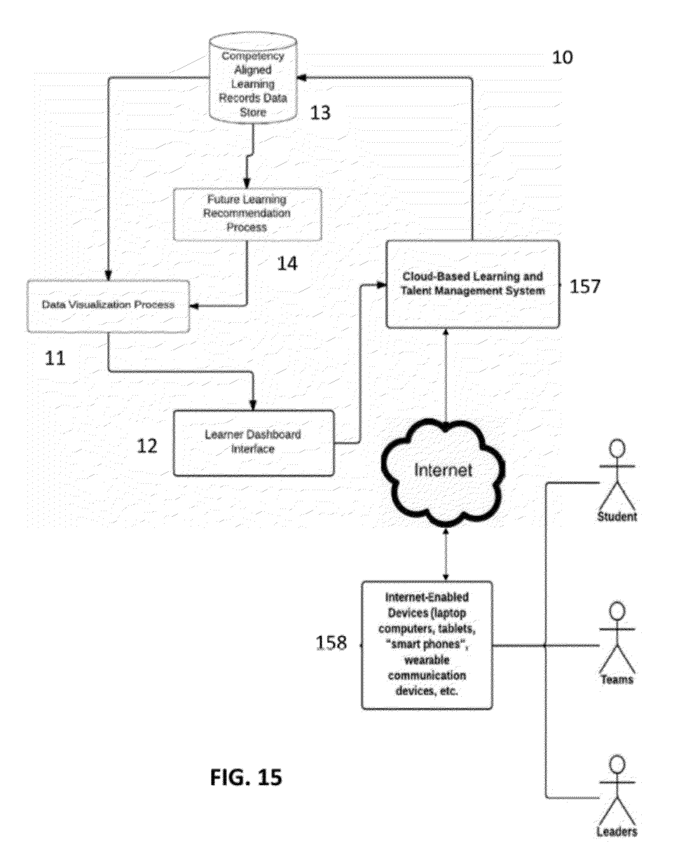

FIG. 15 is a non-limiting diagram showing present invention implemented in cloud-based architecture. This architecture allows learning management system and talent management system providers to seamlessly integrate the competency alignment and recommendation features in these platforms.

In detail: Referring now to FIG. 1, a non-limiting schematic illustration of one embodiment of the present invention shows one configuration of the process flow for the method of the present invention 10. FIG. 1 illustrates the high level system architecture of the invention 10 and how it integrates with common competency based education and learning environments. The components in black line boxes are primary method elements of the invention 10. Other elements shown using dashed lines in the diagram indicate relationships with common competency based education and learning environment components. The methods of the present invention 10 may serve as visualization 11 and communication 12 components for competency based learning. The diagram in FIG. 1 shows how elements specific to the present invention 10 may connect with and support other data elements (15, 19) and processes (17, 18a, 18b) shown in dashed lines. The present invention 10 is structurally different from other inventions in that it can be integrated into any competency based learning environment because it creates a standalone database for storing learning records 11 that have been transformed and aligned with a competency model 16. In another aspect, the present invention 10 provides the user interface and data structures needed to visualize competency based learning records 13 across multiple courses, programs, or experiences. Competency based learning records and future learning opportunities based on a defined competency model 16 may be integrated in a single learner dashboard interface 12.

Further, the present invention 10 may be integrated and used with multiple competency models at the same time. The architecture and methods of the present invention 10 enable use of a single database for storing competency based learning records 13, and then creating unique recommendations using a Future Learning Recommendation Process 14, data graphics, and dashboards for each competency model 16. The methods of the present invention may be applied to all competency based education and learning environments.

Referring now to FIG. 2 a non-limiting schematic illustration of one embodiment of the present invention 10 shows top-level components and relationships of the present invention 10, and illustrates core systematic elements (11 thru 14). The diagram in FIG. 2 shows learning records that have been aligned with competency models (FIGS. 1, 16) and where they may be used in the Future Learning Recommendation Process 14 and the Data Visualization Process 11. The Data Visualization Process 11 may then be used to create a Learner Dashboard 12 that displays both historical competency based learning records and future learning opportunities for learners. This method is different from other methods because it uses only four core components that can be integrated into existing competency based education and learning environments. This makes it well suited for use in many education and learning systems. The present invention comprises:
Competency Aligned Learning Records Store 13
Future Learning Recommendation Process 14
Data Visualization Process 11
Learner Dashboard Interface 12

The Competency-Aligned Learning Records Store 13 shown in FIG. 2 is a database system that integrates all relevant data about a learner's past learning events. The events and records contained in the database are aligned using a defined competency model (FIGS. 1, 16). For example, a student may complete a course on personal finance that aligns with a financial literacy competency. This database contains information about the course, the relationship that course has to a defined competency, and the learner's performance in the course.

Referring now to FIG. 3 a non-limiting diagram is presented showing a process for determining future learning recommendations and how they may be determined using the present invention 10. First, a learner's prior learning records may be analyzed 31 and a matrix developed that identifies a learner's performance on each level of a competency model. Using the profile matrix 31, the learner's progress maybe calculated 32 for each competency level by determining a percent of achievement for each level. Assumptions and rules for a competency model are applied 3. Using predetermined display priorities 34, a list of future learning events 19 that meet the display criteria may be generated. For example, a learner may have completed algebra 1 and algebra 2; however, to meet a mathematics competency, they may need trigonometry 1. In this example, the present invention would identify which future learning events the learner would need to fulfill the mathematics competency.

Referring now to FIG. 3A a non-limiting diagram is shown providing an example of a matrix 36 that may be generated for identifying competency based learning opportunities using the present invention 10. In this example, the competency model (FIGS. 1, 16) has three competencies each with three performance levels. Each competency level (Level 1, 2, and 3) is assigned a specific identifier 37. This identifier is used for aligning past and future learning events with the model (FIGS. 1, 16). The “actual” cell under each Competency Model ID 37 identifies the points 38 the learner has achieved for a given competency level. The “possible” cell identifies the total number of points 38 needed for the learner to demonstrate competency in a given level. The numbers provided in the matrix 36 are for illustration purposes. These numbers may be used to calculate a learner's progress to competency. This may be calculated based on a simple percentage or more complex organizational formulas. For example, the learner has earned a 50% to competency for Competency 3, Level 3.

The percent that a learner has earned towards a competency level (Level 1, 2, and 3) may be used to determine a display priority for future learning events along with assumptions and rules for the competency model. An example of a competency model rule is that a learner must achieve all points in Level 1 before being allowed to earn points towards Level 2 or Level 3. An example of an assumption is that all professionals in a certain field are required to learn Level 3 competencies based on their job requirements. Both rules and assumptions may be used to filter or adjust the display priority of future learning opportunities. The table titled “Priorities for Displaying Future Learning Events” 39 provides an example of possible display priorities.

Referring now to FIG. 4 a non-limiting diagram shows a process for developing visualization assets 46 of competency based learning records and future learning recommendations. The diagram of illustrates how data visualization assets 46 may be developed in the present invention 10. First, the competency model may be analyzed 41 to determine its characteristics and components 42. Next, this analysis may be used to filter the competency based learning records 43 and future learning opportunities 44. After these filters are applied, a visualization strategy 45 may be determined that best conveys the meaning of both historical competency based learning records 43 and future learning recommendations 44. Finally, visualization assets 46 may be developed based on the visualization strategy 45. In the Data Visualization Process (FIGS. 2, 11) of the present invention 10, specific data graphics may be designed and created that display a learner's performance on a competency model and how future learning opportunities are presented to the learner.

The goal of the Data Visualization Process (FIGS. 2, 11) is to design data graphics that most accurately convey the meaning of a learner's progress towards a given competency model. When 15 analyzing a competency model structure, the competencies and competency levels may be identified along with any dependencies that may exist in the model (FIGS. 1, 16). For example, competency 1 (FIG. 3A) must be achieved before a learner can achieve competency 2 (FIG. 3A). These rules and assumptions may also be used in the process of recommending future learning events (FIGS. 3A, 39). Additional rules and assumptions may need to be developed to visualize the learner's progress on a competency model (FIGS. 1, 16). For example, icons or visual symbols may be particularly meaningful to a competency model (FIGS. 1, 16) or audience, and would need to be incorporated accurately in the visual display.

After a complete list of the competency model rules and assumption 42 for the Data Visualization Process (FIGS. 2, 11) is developed, sample data from the Learning Records Store (FIGS. 1, 13) and Future Learning Events (FIGS. 1, 19) may be analyzed to determine the most appropriate visualization strategy 45. During this step, a data visualization designer may consider the most appropriate types of visualization methods and technologies. These methods may include bar charts, pie charts, interactive lists, line graphs, or radial charts. This may also include how various types of visualization methods are combined together in more complex graphical assets. The final step in the Data Visualization Process (FIGS. 2, 11) is developing the data graphic assets that are used to display the learner's progress and future learning opportunities. These visualization assets may be custom developed or may leverage third-party visualization platforms as part of the system.

Referring now to FIG. 5, a non-limiting diagram shows a design and development process for creating the visual interface that integrates the competency based learning records visualizations 54 and the future learning recommendation visualizations 55. First, a functional prototype is developed 51 to test possible layouts, user interactions with the dashboard, and overall user experiences. After a design concept is finalized for the dashboard, the layout and web-based interface is programmed 52. The layout of the dashboard is focused on how the visual display is organized. The next step in this process is integrating the data visualization assets 53 in the developed web-based dashboard interface. The final step in developing the dashboard interface is to integrate 56 needed data connections such as the learning records 57 data store and the list of future learning recommendations 58. The output of this process is a web-based dashboard 59 that displays a learner's competency based learning progress and opportunities for future learning.

This interface 59 can be displayed on Internet enabled devices such as desktop computers, laptop computers, smartphones, and tablets that are available from companies such as Samsung, Apple, Hewlett Packard, Dell, and Microsoft.

The systems and methods of the present invention provide the capability to display competency based data using Internet enabled devices (smartphones, tablets, laptops, desktops, touch interface kiosks, etc.) directly to the learner. This allows learners to access information about their competency records and learning opportunities in real time from virtually any Internet enabled device. This is designed to aid learner's ownership and decision making processes about their education and learning experiences.

Referring now to FIG. 6 a non-limiting diagram (presented in black and white) is shown providing an example visualization display 60 of the present invention 10 comprising three levels of five competencies. The example illustrates a data visualization of a learner's historical competency based learning records using the present invention 10. The dashboard 60 shown is viewable on a at least a tablet device and incorporates visual elements meaningful to the learner within the context of their organization. In this example, badges are used to show achievement of a given competency element, while small multiples are used to show progress toward competency based criteria. Color or gray scale may be used in implementations to better visualize the data displayed.

Referring now to FIG. 7, a non-limiting diagram (presented in black and white) is shown providing an example display 70 comprising individual performance on a competency category of the present invention 10. In the example, competency based visualization is illustrated with a detail screen active for a specific competency level. The detail screen displays the learner's progress for that competency level and provides a call to action to find specific future learning opportunities that would help the learner advance that competency. Color or gray scale may be used in implementations to better visualize the data displayed.

Referring now to FIG. 8, a non-limiting diagram (presented in black and white) illustrates an example display 80 of the present invention 10, comprising individual learner recommendations for future learning opportunities. In this example, the recommendations are based on the learner's past competency records and highlights key future learning pathways that align with the competency model and the learner's progress based on the competency model.

Referring now to FIG. 9, a non-limiting diagram (presented in black and white) illustrates an example display 90 of the present invention 10, comprising a learning opportunity profile with registration capabilities and a selected future learning opportunity. In the example, the detail dialogue displays the title and description, and provides a call to action to register for a learning opportunity. Completing this learning opportunity would contribute to a learner's completion of aligned learning events. Color or gray scale may be used in implementations to better visualize the data displayed.

The methods of the present invention may also include one or more of the following steps:
Visual display of organization competency data
Visualization of gaps in competences for learners
Visualization of gaps in competences for organizations
Game elements (i.e. levels, score, timing, tokens, etc.) integrated into learner dashboard interface
Portable competency-based learning record that is interoperable with organizational human resource and learning platforms.

Referring now to FIG. 10, a sample structure of the Competency Aligned Learning Records Data Store (FIGS. 2, 13) of the present invention 10 is illustrated. This database is designed to align learners' prior learning records 102 with performance data towards a predefined competency model (FIGS. 1, 16). This diagram shows the Master Learning Event Flow 101, which is a total list of a learner's prior learning records. This event flow also contains data unique identifiers for learning events, the learning event title, description, type (i.e. delivery format, etc.), alignment with a competency model level, and a description of the competency model level. This data is pulled together to create the learner's event flow (i.e. complete list of their learning event history) as a Competency Record 104. Basic demographic information 103 about the learner is also used for description purposes.

Referring now to FIG. 11, a non-limiting, high level system diagram is presented showing the components and relationships for how a learning event is recommended using the recommendation decision model 110 approach. In this system, the Recommendation Decision

Model 110 uses data from a learner's historical learning record aligned with competencies (Competency Aligned Learning Records Data Store 111), future learning events aligned with competencies 112, competency models, standards and the pathways used to achieve those competencies (i.e. course sequences, certificates, etc.) 113, and competency-aligned human resource development innovation models (i.e. competency models based on achieving strategic priorities in an organization)114. These data are then applied to a decision model 110 that takes into account competency achievement, distance to competency standard, and importance of innovative human resource development priorities. Recommendations may be provided to a plurality of systems, including a Visualization Dashboard 115, a Learning Management System 116, and a Talent Management System 117. A Recommended Learning Event 118 is determined by the Learning Management System 116 based on a plurality of inputs including user selections made using the Visualization Dashboard 115, recommendations from the Decision Model 116, and needed skill received from the Talent Management System 117. Completed learning events are recorded in the Competency Aligned Learning Records Store 111.

Referring now to FIG. 12, a conceptual representation is presented (in black and white) showing how competency-based data is applied to the competency-based decision model of the present invention 10 and used to determine recommendations based on decision rules. In this illustration, each bar represents progress towards on a competency pathway. The bottom section of each bar shaded in black is competency achievement 121 which is the learners' historical performance towards a competency. Portions of the bar for C2 and C4 may be shaded in a color (e.g. red in lieu of white) to represent competency gaps 122. These are the remaining competency pathway elements needed to meet the competency standard 123 or goal represented by the horizontal bar atop C2 and C4. The standard/goal 123 is represented by the solid horizontal bar on a competency pathway. The section of the bar on C1 and C3 above the horizontal bar shaded in black represents competency achievement above the defined competency standard 124. This conceptual rendering shows how learner's achievement, competency gaps, and areas of expertise are incorporated in the decision model to develop recommendations. This aspect of the invention 10 is novel because it provides a method for recommending future learning events in a competency-based structure using historical learner performance and strategic human resource development goals. This allows organization leaders to “tune” the competency model (FIGS. 1, 16) based on the needs/talent gaps in the organization. Color or gray scale may be used in implementations to better visualize the data displayed.

Referring now to FIG. 13, a non-limiting example is presented (in black and white) illustrating a decision model 130 that could be used to recommend future competency-aligned learning events. In this decision model 130 of the present invention 10, the competencies (C1 through C4) are listed in the first column. The second column is the percent of the complete competency pathway. The third column is the innovation priority which defines the priority placed on that competency based on strategic human resource development needs. The fourth column is the recommendation score and in this model 30, is calculated by multiplying the percent of the pathway complete with the priority number. The recommendation priority defines which learning events are recommended in a given priority based on their alignment with a competency. In this example, the priority 1 is based on the lowest recommendation score because the decision model aims to balance innovation priorities within the set competency model. These recommendations might be used by supervisor, employees, and leaders to establish learning experiences based on an established decision model. These decision models may change and adapt over time based on the needs of the workforce or strategic priorities of the organization. This approach allows organizations to be intentional and strategic about how competencies are developed among the workforce. Color or gray scale may be used in implementations to better visualize the data displayed.

Referring now to FIG. 14, a non-limiting diagram is presented showing key attributes of a competency. The competency ID 141 contains a description, performance type (knowledge, skill, attitude) 142, pathway type (sequential, nominal) 143, and the events that make up the pathway to achieving the competency 144. These attributes are used to determine which learning event should be recommended. For example, if a learning event has associated attributes from a competency, a recommendation engine that may operate in the Recommendation Process (FIGS. 1, 14) will determine if the learning event must align in a sequence or if any events can be completed in any order. One of the key criteria for this method to accurately recommend competencies based on historical learner performance and defined human resource development outcomes is understanding the attributes and structure of competencies. In order for a decision-model (FIGS. 1, 16) to recommend learning events, each competency may selectively define the competency pathway, or the route through which a learner must travel to achieve competency depending on their past achievements. For example, if a competency requires sequential events, these sequences will need to be defined using a tagging system or alternate identification method. In contrast, if there is no defined sequence to a competency, a learner could complete any series of tasks in any order and meet the competency standard. In some situations, a competency may be a learning event in another competency, making these two competencies dependent on one another. This system is a way of describing key attributes about a competency and competency pathway.

The present invention captures data from multiple data sources that contain information relevant to a learner's competency based learning records (i.e. learning management systems, portfolios, etc.) and stores it in a single database (Competency Aligned Learning Records Store) (see FIG. 1). This data is then used in the Future Learning Recommendation Process (FIG. 3), along with available learner demographic data, a competency model, and future learning events (see FIG. 1), to identify possible future learning that fulfill competency based learning opportunities. These personalized recommendations are then used in the Data Visualization Process (see FIG. 4) that organizes and presents a learner's historical learning records and the recommendations for future learning opportunities using competencies as the major information organization strategy. These visualizations of a learner's competency based learning records and recommended future learning opportunities are then displayed to the learner through the Learner Dashboard Interface in real time (see FIGS. 5-9).

In addition to visualizing competency-based learning records and recommendations, this invention (FIGS. 1, 10) provides a method for creating decision models for recommending future learning events using learning records based on a competency learning structure and strategic human resource development priorities. This aspect of the invention customizes recommendations based on the performance needs of individuals, teams, and organizations using a systematic approach. These decision models can also be developed and customized to achieve certain learning and performance outcomes through the use of competency-aligned learning events. The decision-models that define how competency-aligned learning experiences are recommended establish the interoperable component that can be applied to diverse learning-recommendation systems.

The present invention (FIGS. 1, 10) provides a method for recommending future learning events based on competency achievement and strategic human resource development priorities. This method uses an interoperable approach to creating recommendation decision models for competency-based learning events. Different recommendation decision models may be developed based on the goals and needs of an individual or organization. In addition, different decision models may be more effective at accomplishing certain types of human resource development outcomes. For example, if an organization is developing a new product line, this competency-based approach provides a method for proactively equipping a workforce based on the anticipated needed knowledge and skills. This is accomplished by adjusting the decision model to value innovation opportunities. In contrast, if employees report needing additional professional development opportunities as a job satisfaction measure, a decision model can be designed to balance that outcome with organizational performance. While these two examples serve different purposes, they are both based on alignment with competencies and competency pathways.

Using the present invention (FIGS. 1 10), decision-models can be created, shared, and customized based on the priorities and needs of individuals, teams, and organizations. This makes the decision models interoperable and easily customized based on strategic priorities. The method of the present invention may be incorporated in an organization's learning management system as a way of recommending future learning events based on historical learning performance and strategic priorities. For example, continuing education providers such as seen in medical, law, or technical fields could use this method to create visualization dashboards for showing customers progress on competency-aligned training while using an optimized decision model for recommending future learning events based on define competency outcomes. This could also be particularly useful for product training applications by aligning competency performance with specific use goals of a device or application.

Referring now to FIG. 15, the present invention (FIGS. 1, 10) is shown implemented in cloud-based architecture, and includes:
Competency Aligned Learning Records Store 13
Future Learning Recommendation Process 14
Data Visualization Process 11
Learner Dashboard Interface 12.

This architecture allows providers 157 of learning management systems and talent management systems to seamlessly integrate the competency alignment and recommendation features in these platforms. Integrated in talent management systems 157, use as a leadership and human resource development tool is enabled for strategic planning and managing change. These systems are then accessible to the point of view of a student, team, or organization 158 which allows the competencies to be aggregated and applied, and permits multiple perspectives. This would enable use for team development, identifying skill gaps in organizations, or preparing for and managing change. Access through the cloud (e.g., Internet) by student, team, or organization 158 members may be achieved using any device possessing a display, memory, and an operating system capable of running a program that controls communications including desktop computers, laptop computers, tablet computers and mobile devices such as “smart phones” and wearable communication devices.

An exemplary computer program code listing is provided in APPENDIX A for a prototype that illustrates how various elements of the present invention can come together. A limited working dashboard prototype with local html data is included. The code is annotated to show how elements may be integrated together. The code is 27 pages, and provides a detailed implication approach. A number of third-party webkits and libraries were used to build the functional prototype dashboard code in an html file. Also, a few screenshots of the prototype are provided in APPENDIX B. The computer program code presented is operable as a web app on the iPad available from Apple, Inc.

Those skilled in the art will appreciate that in some embodiments of the invention, the functional modules of the Web implementation, as well as the personal and the integrated communication devices, may be implemented as pre-programmed hardware or firmware elements (e.g., application specific integrated circuits (ASICs), electrically erasable programmable read-only memories (EEPROMs), etc.), or other related components. Mobile communication devices that can use the present invention may include but are not limited to any of the “smart” phones or tablet computers equipped with digital displays, wireless communication connection capabilities such as iPhones and iPads available from Apple, Inc., as well as communication devices configured with the Android operating system available from Google, Inc. In addition, it is anticipated the new communication devices and operating systems will become available as more capable replacements of the forgoing listed communication devices, and these may use the present invention as well.

In other embodiments, the functional modules of the mobile-to-cloud implementation may be implemented by an arithmetic and logic unit (ALU) having access to a code memory which holds program instructions for the operation of the ALU. The program instructions could be stored on a medium which is fixed, tangible and readable directly by the processor, (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The program instructions stored in the code memory can be compiled from a high level program written in a number of programming languages for use with many computer architectures or operating systems. For example, the high level program may be written in assembly language such as that suitable for use with a pixel shader, while other versions may be written in a procedural programming language (e.g., “C”) or an object oriented programming language (e.g., “C++” or “JAVA”).

In other embodiments, cloud computing may be implemented on a web hosted machine or a virtual machine. A Web host can have anywhere from one to several thousand computers (machines) that run Web hosting software, such as Apache, OS X Server, or Windows Server. A virtual machine (VM) is an environment, usually a program or operating system, which does not physically exist but is created within another environment (e.g., Java runtime). In this context, a VM is called a “guest” while the environment it runs within is called a “host.” Virtual machines are often created to execute an instruction set different than that of the host environment. One host environment can often run multiple VMs at once.

While specific embodiments of the present invention have been described and illustrated, it will be apparent to those skilled in the art that numerous modifications and variations can be made without departing from the scope of the invention as defined in the appended claims. It is understood that the words that have been used are words of description and illustration, rather than words of limitation. Although the invention has been described with reference to particular means, materials and embodiments, the invention is not intended to be limited to the particulars disclosed; rather, the invention extends to all functionally equivalent structures, methods and uses, such as are within the scope of the appended claims.

I claim:

1. A method for visualizing competency based learning data supporting learner decision making, comprising:
providing a decision support module that integrates all relevant data about past learning events of said learner transformed and aligned using a defined competency model;
executing a process for recommending future learning opportunities rooted upon current competency based performance of a learner and identifying future learning events said learner would need to fulfill for a specific competency;
creating and graphically displaying said competency based performance according to said defined competency model and presenting future learning opportunities to said learner, and
providing a dashboard interface usable by said learner to view past competency based learning records and suggestions for future learning opportunities.

2. The method of claim 1, further comprising
visual display of organization competency data;
visualization of gaps in competences for learners;
visualization of gaps in competences for organizations, and selecting future learning events.

3. The method of claim 1, incorporating game elements including at least levels, score, timing, and tokens integrated into said learner dashboard interface.

4. The method of claim 1, further comprising creating a portable competency-based learning record interoperable with organizational human resource and learning platforms.

5. The method of claim 1, wherein multiple sources of educational records including grades, course scores, rubric assessments are combined with defined competency models, and future learning opportunities for presentation in said learner dashboard interface.

6. The method of claim 1, wherein the dashboard interface can be displayed on Internet enabled devices such as desktop computers, laptop computers, smartphones, and tablets.

7. A computer system for matching learning opportunities and events with learner competency requirements, comprising:
a competency characterization module resident on a server system and configured to integrate all relevant data about a learner's past learning events transformed and aligned using a defined competency model;
a competency requirements module resident on said server system and configured to execute a process for recommending future learning opportunities rooted upon a learner's current competency based performance and identifying future learning events the learner would need to fulfill for a specific competency;
a display module for visually presenting a learner's performance according to said competency model and presenting future learning opportunities and events to said learner,
a dashboard interface usable by said learner to view their past competency based learning records and recommendations for future learning opportunities, and in decision making.

8. The system of claim 7, wherein said learner dashboard interface is usable for
visualization of organization competency data;
visualization of gaps in competences for learners;
visualization of gaps in competences for organizations, and selecting future learning events.

9. The system of claim 7, wherein said learner dashboard interface incorporates game elements including at least levels, score, timing, and tokens.

10. The system of claim 7, further comprising a portable competency-based learning record interoperable with organizational human resource and learning platforms.

11. The system of claim 7, wherein the dashboard interface can be displayed on Internet enabled devices such as desktop computers, laptop computers, smartphones, and tablets.

12. The system of claim 7, wherein decision-models define how competency-aligned learning experiences are recommended and establish the interoperable component that can be applied to diverse learning-recommendation systems.

13. The system of claim 7, wherein said competency requirements module is configured to dynamically request information concerning learner competency.

14. The system of claim 7, wherein said server system is configured in a cloud-based architecture that integrates competency alignment and recommendation functions into at least one of a learning management system and a talent management system.

15. A mobile electronic device configured for visualizing competency based learning data, comprising:
a communication interface for accessing at least one record store that integrates relevant data about past learning events of a learner transformed and aligned using a defined competency model;
a competency characterization module executing a process for recommending future learning opportunities rooted upon current competency based performance of said learner and identifying future learning events said learner would need to fulfill for a specific competency;
a display module for visually presenting a performance of a learner according to said defined competency model and presenting at least one of future learning opportunities and events to said learner,
a dashboard interface usable by said learner to view their past competency based learning records and recommendations for future learning opportunities, and in decision making.

16. The mobile electronic device of claim 15, where said learner dashboard interface is usable for
visualization of organization competency data;
visualization of gaps in competences for learners;
visualization of gaps in competences for organizations, and
selecting future learning events.

17. The mobile electronic device of claim 15, wherein said learner dashboard interface incorporates game elements including at least levels, score, timing, and tokens.

18. The mobile electronic device of claim 15, wherein future learning events are recommended based on competency achievement and strategic human resource development priorities.

19. The mobile electronic device of claim 15, wherein said at least one record store is resident on a server system configured in a cloud-based architecture.

20. The mobile electronic device of claim 19, wherein a recommendation decision model resident on said server system uses data from said records store, future competency-aligned learning events, competency models, and talent-aligned human resource development innovation models to create recommendations that can be surfaced in said competency dashboard and accessed by a learning management system, or talent management system.
